(19) United States
(12) Patent Application Publication
(10) Pub. No.: US 2017/0155629 A1
(43) Pub. Date: Jun. 1, 2017

(54) NETWORK-BASED USER AUTHENTICATION DEVICE, METHOD, AND PROGRAM THAT SECURELY AUTHENTICATE A USER'S IDENTITY BY USING A PRE-REGISTERED AUTHENTICATOR IN A REMOTE PORTABLE TERMINAL OF THE USER

(71) Applicant: YAHOO JAPAN CORPORATION, Tokyo (JP)

(72) Inventors: Hidehito GOMI, Tokyo (JP); Wataru OOGAMI, Tokyo (JP)

(73) Assignee: YAHOO JAPAN CORPORATION, Tokyo (JP)

(21) Appl. No.: 15/263,855

(22) Filed: Sep. 13, 2016

(30) Foreign Application Priority Data
Nov. 27, 2015 (JP) 2015-232369

(51) Int. Cl. H04L 29/06

(52) U.S. Cl. CPC H04L 63/062; H04L 63/102

(57) ABSTRACT

A network-based user authentication device, method, and program securely authenticate a user's identity by using a pre-registered authenticator in a remote portable terminal of the user. The device, method, and program transmit an identity verification request that requests verification of the user's identity by a pre-registered authenticator to the remote portable terminal, and receive, in response to the verification request, authentication information from the remote portable terminal. The authentication information identifies the user of the remote portable terminal and includes a secret key. The device, method, and program validate the authentication information by comparing the received secret key with a validation code associated with the user in a memory, and, when the received secret key and the validation code associated with the user correspond, generate identity verification information confirming the identity of the user. The device, method, and program then transmit the generated identity verification information to the remote portable terminal.

### CROSS-REFERENCE TO RELATED APPLICATION

The present application claims priority to and incorporates by reference the entire contents of Japanese Patent Application No. 2015-232369, filed in Japan on Nov. 27, 2015.

### BACKGROUND

1. Related Technical Fields

Related technical fields include network-based user authentication devices, methods, and programs that securely authenticate a user's identity by using a pre-registered authenticator in a remote portable terminal of the user.

2. Description of the Related Art

Communication networks have recently become widely available, and services provided over communication networks are now thriving. Services leveraging information managed online to expand their services to offline services (services in the real world) are also being developed now. As an example, being developed now are services allowing a user to receive a product in a real-world store, after the user registers his/her user information and makes the payment online.

In relation to such a service, a technology has been developed in which a store is enabled to acquire some pieces of user information, before a user receives the service at the store, from a management server where the user information is managed, and to provide the service to the user using only the pieces of user information that are required for providing the service, among those pieces acquired from the management server. An example of such a technology is described in Japanese Laid-open Patent Publication No. 2014-056550.

### SUMMARY

The conventional technology described above is, however, has a problem by virtue of the user information being transmitted over a network in that it is not quite capable of using the information managed online efficiently. With the conventional technology, for example, in order to enable a store to verify the identity of the user who is to use the service, the store is required to perform tasks such as receiving a submission of an image of a user beforehand, and having a store clerk to compare the face of the user with the face in the image. The store may be alternatively required to install some special device with information matching capability (e.g., matching biological information such as an image of a face or a voiceprint) for the identity verification. Despite of such efforts for making good use of network-based information managed online, these approaches require an enormous amount of resources, such as work and time, for a real-world store to verify the identity of each and every user, and such burdens sometimes make it difficult for the store to efficiently provide the service.

It is an object of exemplary embodiments of the broad inventive principles described herein to at least partially solve these network-based problems in the conventional technology.

Exemplary embodiments provide a network-based user authentication device, method, and program securely authenticate a user's identity by using a pre-registered authenticator in a remote portable terminal of the user. The device, method, and program transmit an identity verification request that requests verification of the user's identity by a pre-registered authenticator to the remote portable terminal, and receive, in response to the verification request, authentication information from the remote portable terminal. The authentication information identifies the user of the remote portable terminal and includes a secret key. The device, method, and program validate the authentication information by comparing the received secret key with a validation code associated with the user in a memory, and, when the received secret key and the validation code associated with the user correspond, generate identity verification information confirming the identity of the user. The device, method, and program then transmit the generated identity verification information to the remote portable terminal.

The above and other objects, features, advantages and technical and industrial significance will be better understood by reading the following detailed description of the exemplary embodiments, when considered in connection with the accompanying drawings.

### BRIEF DESCRIPTION OF THE DRAWINGS

FIG. 1 is a schematic illustrating a configuration of a user information management system according to an embodiment;

FIG. 2 is a first sequence chart for explaining an identity verification process according to the embodiment;

FIG. 3 is a second sequence chart for explaining the identity verification process according to the embodiment;

FIG. 4 is a schematic illustrating an example of a user information management process according to the embodiment;

FIG. 5 is a schematic illustrating an exemplary configuration of a user information management apparatus according to the embodiment;

FIG. 6 is a schematic illustrating an example of a user information storage unit according to the embodiment;

FIG. 7 is a schematic illustrating an example of an authentication information storage unit according to the embodiment;

FIG. 8 is a schematic illustrating an example of a service information storage unit according to the embodiment;

FIG. 9 is a schematic illustrating an exemplary configuration of a user terminal according to the embodiment;

FIG. 10 is a schematic illustrating an example of an authenticator information storage unit according to the embodiment;

FIG. 11 is a schematic illustrating an exemplary configuration of a facility apparatus according to the embodiment;

FIG. 12 is a schematic illustrating an example of a service usage information storage unit according to the embodiment;

FIG. 13 is a flowchart illustrating the procedure of a process according to the embodiment;

FIG. 14 is a schematic illustrating an example of a user information management process according to a modification; and

FIG. 15 is a schematic illustrating an exemplary hardware configuration of a computer implementing the function of the user information management apparatus.

### DETAILED DESCRIPTION OF THE PREFERRED EMBODIMENTS

An embodiment will now be explained in detail with reference to some drawings. The embodiment described below, however, need not limit the broad inventive principles. Elements that are the same among the embodiments are given the same reference numerals, and redundant explanations thereof are omitted.

### 1. System Configuration

Explained now in the embodiment is an exemplary user information management system 1 in which identity authentication is executed by a terminal owned by a user, and the identity of the user is then verified by an apparatus managing the user information by validating the authentication performed by the terminal, to enable a facility, providing a service based on the identity verification, to provide the service to the user.

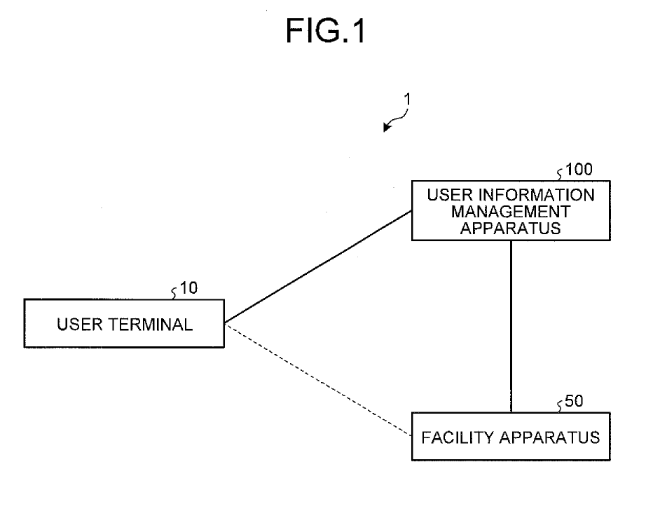

FIG. 1 is a schematic illustrating a configuration of the user information management system 1 according to the embodiment. As illustrated in FIG. 1, the user information management system 1 includes a user terminal 10, a facility apparatus 50, and a user information management apparatus 100. The user terminal 10 and the user information management apparatus 100, and the facility apparatus 50 and the user information management apparatus 100 are communicatively connected to each other over a network not illustrated. The network may be any communication network such as the Internet, a local area network (LAN), a virtual private network (VPN), or a mobile communication network, regardless of whether the network is a wired or wireless network. In the example illustrated in FIG. 1, the user terminal 10 and the user information management apparatus 100, and the facility apparatus 50 and the user information management apparatus 100 are both connected with solid lines to represent that these connections are online, and the user terminal 10 and the facility apparatus 50 are connected with a dotted line to represent that the connection is offline. The user terminal 10 and the facility apparatus 50 may become connected to each other via a predetermined near field communication before information is exchanged in the manner described below. In the example of the user information management system 1 illustrated in FIG. 1, the user terminal 10 and the facility apparatus 50 are both provided in singularity, but the system according to the present embodiment is not limited to such a configuration, and the user terminal 10 and the facility apparatus 50 may be provided in any number. The user information management system 1 may also include the user information management apparatus 100 in plurality.

The user terminal 10 is an information processing terminal device carried by a user. Examples of the user terminal 10 include a smartphone, a tablet personal computer (PC), a laptop PC, a mobile phone, and a personal digital assistant (PDA). The user terminal 10 has a function for authenticating the identity of the user who is operating the terminal. For example, the user terminal 10 receives a registration of fingerprint data from the user, as biological information to be used in the authentication. The user terminal 10 also prompts the user who is using the user terminal 10 to input his/her fingerprint data in a predetermined situation. The user terminal 10 then authenticates the user by determining whether the user is the person him/herself who has registered the fingerprint data in advance, based on the matching of the fingerprint data.

The facility apparatus 50 is an apparatus that is deployed in a facility or a store (hereinafter, simply referred to as a “facility”) that is a service provider that provides a predetermined service. Examples of the facility apparatus 50 include information processing apparatuses such as a desktop PC, a tablet PC, a laptop PC, and a point-of-sale (POS) terminal performing accounting for the facility. The facility apparatus 50 may sometimes check whether the user who is attempting to use the service is an appropriate person for receiving the service. It is assumed herein that the facility is a concert hall, as an example. The facility sells concert tickets online, before the day on which the concert is held, and grants a user with a privilege for receiving the ticket offline, that is, a privilege for participating in the concert. On the day when the concert is held, the user who is attempting to participate in the concert is requested, at the facility, to present information certifying that the user has the privilege. The user presents the information certifying that the user has purchased the concert ticket to the facility apparatus 50, using the user terminal 10. The facility apparatus 50 then validates whether the user carrying the user terminal 10 is a user who has really purchased the ticket. In other words, the facility apparatus 50 validates whether the user is a user who has a legitimate privilege. Once the user is determined to be a legitimate user, the facility apparatus 50 then issues a ticket to the user, or admits the user to the concert hall.

The user information management apparatus 100 is an information processing apparatus such as a server computer that manages various types of user-related information. The user information management apparatus 100 stores therein various types of user information related to users. The user information management apparatus 100 stores therein, as an example of the user information, privilege information indicating that a user has a privilege for receiving a service provided by the facility apparatus 50. The user information may include different types of private information such as the name, the address, the date of birth, or the age of the user. The user information is registered to the user information management apparatus 100 by the user via the user terminal 10, for example. The user information management apparatus 100 may register the user information after an administrator or the like of the user information management apparatus 100 determines that the information submitted by the user is legitimate. The legitimacy of the submitted information is determined based on, for example, whether a public certificate is appended to the information.

The user information management apparatus 100 also manages information related to user authentication, in addition to the private user information. For example, the user information management apparatus 100 manages information related to the identity authentication performed by the user using the user terminal 10. The user information management apparatus 100 then validates whether there is no problem in the authentication executed on the user terminal 10, that is, whether the user authenticated on the user terminal 10 is the user him/herself who has been registered in advance.

The user information management apparatus 100 may perform such a process of identity verification at the timing at which the user receives the service in the real world, as well as at the timing at which the service-related privilege is granted to a user online. In this manner, the user information management apparatus 100 can certify that the user granted with the service-related privilege is the same as the user who is attempting to receive the service in the real world. When the user information management apparatus 100 determines that the authentication performed by the user terminal 10 has no problem, the user information management apparatus 100 generates identity verification information indicating that the identity of the user has been verified. In other words, the user information management apparatus 100 generates the identity verification information certifying that the user him/herself is the user who has the privilege to receive the service, and the facility apparatus 50 can verify the identity of the user to whom the service is provided by referring to the generated identity verification information. Use of such identity verification information can reduce the human-work burden and the like imposed on the facility-side personnel in authenticating each and every user who actually visits the facility in an attempt to receive the service in the real world.

### 2. Identity Verification Process

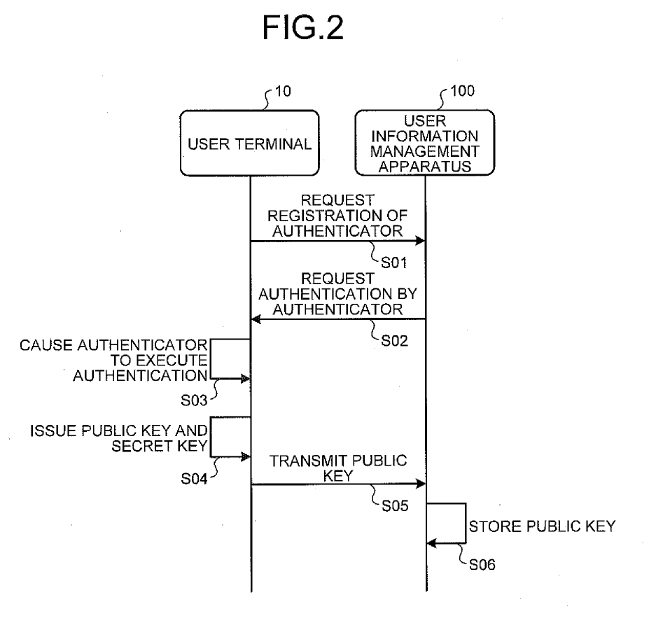

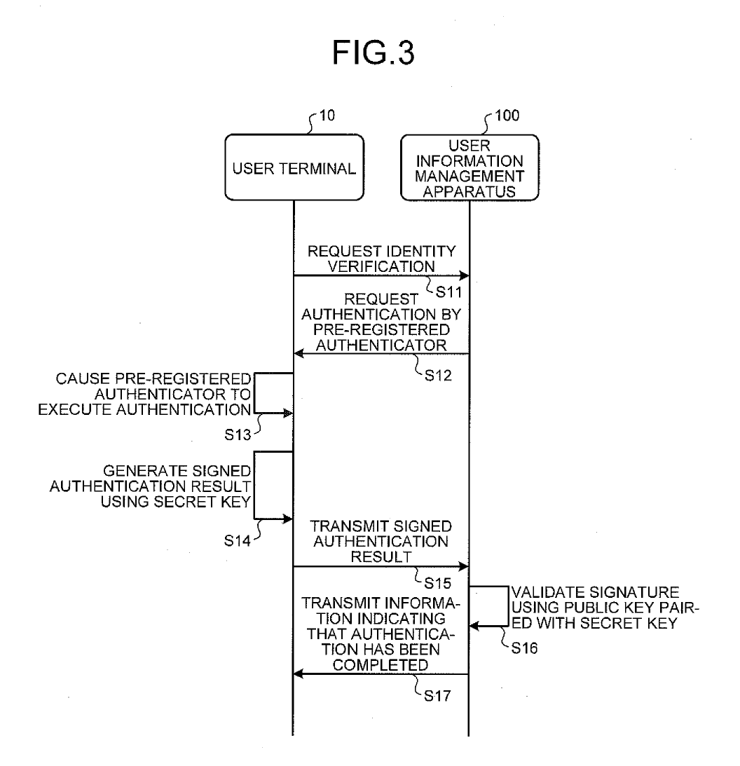

In the process described above, it is preferable for the authentication executed on the user terminal 10 to be validated using a reliable scheme. The user information management apparatus 100 therefore validates the authentication executed on the user terminal 10 using the scheme described below, in order to verify the identity of the user. An example of the scheme by which the user information management apparatus 100 verifies the identity of the user who is using the user terminal 10 will now be explained with reference to FIGS. 2 and 3.

To validate the authentication executed on the user terminal 10, the user information management apparatus 100 uses a validation scheme that is based on what is called public key encryption, in which the credibility of the information is ensured by encrypting and decrypting the information with a pair of a public key and a secret key that are issued in advance. In other words, the user information management apparatus 100 validates the authentication result based on a pair of a public key and a secret key issued to an authenticator that is included in the user terminal 10. An authenticator herein is a function (or an apparatus having such a function) for allowing the user terminal 10 to perform local identity authentication. The local authentication herein is authentication in which registered data registered in advance, for the purpose of user authentication, is matched against input data that is input by the user him/herself, using a function internalized in the user terminal 10, for example, without any involvement of the user information management apparatus 100. The authentication may also be authentication executed without requiring any connection to a wide area network (external network), such as the Internet.

The authenticator receives a registration of information by which the identity of the user can be authenticated, such as the biological information of the user, in advance. At the time of authentication, the authenticator receives an input of the biological information, for example, from the user, and authenticates the user identity based on the result of matching the input data against the registered data. Specifically, examples of the authenticator include a fingerprint authenticator, an iris authenticator, and a voiceprint authenticator. The authenticator may be implemented as software installed in the user terminal 10, or as hardware or the like located within the range that is connectable from the user terminal 10 via a LAN. In other words, an example of the authenticator includes hardware or the like that cooperates with the user terminal 10 by being connected to an interface provided to the user terminal 10, for example, without being connected via a wide area network such as the Internet. The authenticator may also be understood as an authentication function functioning on the user terminal 10, or as an authentication means.

To begin with, the process in which the user information management apparatus 100 registers the authenticator included in the user terminal 10 will be explained. FIG. 2 is a first sequence chart for explaining the identity verification process according to the embodiment. Illustrated in FIG. 2 is a sequence of a process of making a registration related to the authenticator that executes the authentication on the user terminal 10 to the user information management apparatus 100, before the user terminal 10 executes the authentication.

To begin with, the user terminal 10 accesses the user information management apparatus 100, and requests a registration of the authenticator from the user information management apparatus 100 (Step S01). In response to the request received from the user terminal 10, the user information management apparatus 100 requests authentication from the authenticator (Step S02).

The user who is using the user terminal 10 operates the authenticator having requested the registration from the user information management apparatus 100, and executes the authentication locally with the authenticator (Step S03). For example, when the user selects a fingerprint authenticator as the authenticator used in the authentication, the user holds his finger above a predetermined position to execute the authentication. The authenticator then matches the data input by the user with the data registered in the authenticator. If the authenticator confirms that these pieces of fingerprint data match, that is, when the authenticator confirms that the user is a legitimate user, the authenticator issues a public key and a secret key corresponding to the authentication (Step SO4). The user terminal 10 then stores the issued secret key in the user terminal 10, and transmits the public key that is paired with the secret key to the user information management apparatus 100 (Step SO5). The user information management apparatus 100 receives the public key from the user terminal 10, and stores the public key in a manner mapped to the authenticator (Step S06). The secret key that is internal to the user terminal 10 is stored in an area where no access is permitted unless local authentication with the authenticator is successfully completed. Once the pair of the public key and the secret key that are mapped to the authenticator are issued, and the secret key and the public key are registered to the user terminal 10 and the user information management apparatus 100, respectively, the registration of the authenticator in the user information management apparatus 100 is completed.

FIG. 3 will now be explained. FIG. 3 is a second sequence chart for explaining an identity verification process according to the embodiment. FIG. 3 illustrates a sequence of the identity verification process for verifying whether the user who is carrying the user terminal 10 is actually the legitimate user, before the user terminal 10 receives a service.

The user terminal 10 requests identity verification from the user information management apparatus 100 (Step S11). This request is made in order to cause the user information management apparatus 100 to certify that the user who is carrying the user terminal 10 is a legitimate user for using the user terminal 10. This request may, alternatively, be transmitted from the side of the service provider (for example, the facility apparatus 50). In other words, in the process in which the user attempts to receive the service, the user is sometimes requested by the service provider to perform the authentication. In such a case, if the user agrees to perform the authentication, such information is transmitted from the user terminal 10 or from the service provider (the facility apparatus 50) to the user information management apparatus 100.

Upon receiving the request, the user information management apparatus 100 requests the user terminal 10 to perform the authentication using the pre-registered authenticator (Step S12). The user of the user terminal 10 receiving the request executes the local authentication using the pre-registered authenticator (Step S13).

If the authentication with the authenticator succeeds, that is, if the local identity authentication succeeds, the user terminal 10 is permitted to access the secret key stored in the user terminal 10. The user terminal 10 then generates a signature (for example, a hash value) corresponding to information related to the authentication result, using the secret key that can only be accessed by a user who is validated to be a legitimate user by the authenticator. In other words, the user terminal 10 generates an authentication result appended with the signature (hereinafter, referred to as a “signed authentication result”) using the secret key having been issued in advance (Step S14).

The user terminal 10 then transmits the generated signed authentication result to the user information management apparatus 100 (Step S15). The user information management apparatus 100 validates the signature that is appended to the received signed authentication result, using the public key that is paired with the secret key (Step S16). In other words, the user information management apparatus 100 validates whether the signed authentication result is modified, that is, whether the signed authentication result is generated using an appropriate secret key.

As mentioned earlier, the access to the secret key is permitted only when the authentication on the user terminal 10 succeeds. When the signature appended to the authentication result is successfully validated with the public key paired with the secret key, it means that the signature has been generated with the appropriate secret key in the user terminal 10. In other words, the authentication on the user terminal 10 is completed by the registered legitimate user. With this result, the user information management apparatus 100 can confirm that the legitimate user has been authenticated on the user terminal 10. If such legitimacy is confirmed, the user information management apparatus 100 acknowledges the user who is using the user terminal 10 as the legitimate user, based on the signed authentication result. The user information management apparatus 100 then transmits identity verification information that is information indicating that the identity of the user who is using the user terminal 10 has been verified to the user terminal 10 (Step S17). The identity verification information is implemented by an authentication cookie, for example.

In this manner, by following the procedure of the identity verification process, the user terminal 10 does not need to send any information used in the authentication, e.g., a password or a service ID which is often used in general authentication, over the network. In other words, the user terminal 10 transmits only information indicating the result of the local authentication. This configuration can prevent any person from making any use of the information transmitted from the user terminal 10, even if such information is eavesdropped by any third party. Therefore, security can be ensured. With such processing, the user information management apparatus 100 or the facility apparatus 50 does not need to retain biological information or the like of users, even during the process of verifying the user identity. Furthermore, because, in principle, the authentication executed on the user terminal 10 uses the information collected from the user him/herself (e.g., biological information), spoofing, e.g., unauthorized use of a password, by any third party can be prevented.

The user information management apparatus 100 may use a specific authentication protocol in processing the signed authentication result received from the user terminal 10. The specific authentication protocol herein means an authentication protocol agreed between the user information management apparatus 100 and the user terminal 10, and can also be said to be a communication-related protocol. For example, the user information management apparatus 100 may use a protocol such as the Universal Authentication Framework (UAF) or the Universal Second Factor (U2F). With such a protocol, higher security can be ensured in the communication between the user information management apparatus 100 and the user terminal 10. Furthermore, although, in principle, the local authentication executed on the user terminal 10 takes place in an environment that does not require any connection to a wide area network such as the Internet, a network may be used in a certain process. For example, as a function for facilitating the data matching in the authentication, the user terminal 10 may perform a process such as communicating with a predetermined server, and completing the matching via the predetermined server.

### 3. Example of User Information Management Process

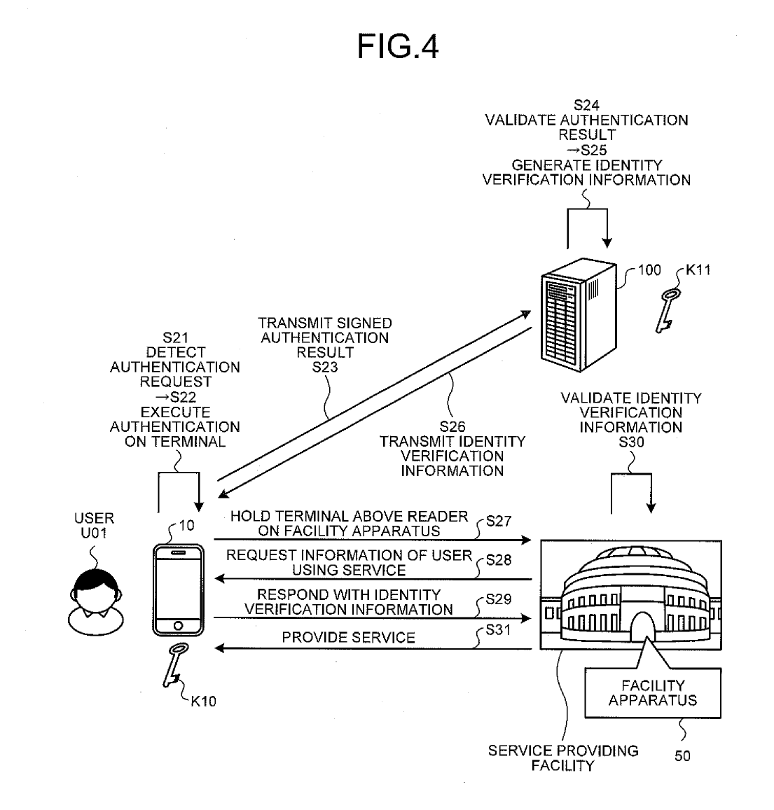

As explained with reference to FIGS. 2 and 3, in the user information management system 1, the identity verification process is executed between the user information management apparatus 100 and the user terminal 10, and in the user information management system 1, the facility provides the service based on the result of the identity verification process. This point will now be explained with reference to FIG. 4, following an exemplary user information management process according to the embodiment.

FIG. 4 is a schematic illustrating an example of the user information management process according to the embodiment. In the example illustrated in FIG. 4, it is assumed that a user U01 of the user terminal 10 has a privilege to receive the service to be provided by the facility. Specifically, in the example illustrated in FIG. 4, the facility is a concert hall, and the user U01 has purchased an online ticket for a concert that is to be held in the facility. Such privilege information is retained in the user information management apparatus 100. It is also assumed that the user terminal 10 has had its authenticator registered to the user information management apparatus 100, and retains therein a secret key K10 as a key corresponding to the authenticator. It is also assumed that the user information management apparatus 100 retains therein a public key K11 as a key corresponding to the secret key K10.

The user U01 visits the facility to participate in the concert to be held in the facility. In the facility, the user terminal 10 detects an authentication request (Step S21). The authentication request at Step S21 is a request issued by the facility to the user, asking the user to have him/herself certified that the user who is carrying the user terminal 10 has a privilege to participate in the concert. The user terminal 10 detects the authentication request at Step S21 by receiving a communication transmitted by the facility apparatus 50, an access point, or a beacon deployed in the facility, for example.

The user terminal 10 receiving the authentication request executes the authentication on the terminal (Step S22). Specifically, the user U01 starts the authenticator included in the user terminal 10, and performs a process of authenticating the user U01 him/herself. For example, the user U01 inputs his/her fingerprint data by holding his/her finger above the user terminal 10. The user terminal 10 then matches the input data with the data registered in the authenticator to authenticate the user U01. The user terminal 10 then generates a signed authentication result by appending a signature to the authentication result indicating that the user U01 has been authenticated, using the secret key K10. The user terminal 10 then transmits the signed authentication result to the user information management apparatus 100 (Step S23).

The user information management apparatus 100 validates the signed authentication result received from the user terminal 10 using the public key K11 (Step S24). In other words, the user information management apparatus 100 validates whether the signature has been generated using the secret key K10. If the validation as to whether the signature has been generated using the secret key K10 is successful, the user information management apparatus 100 determines that the authentication has been performed on the user terminal 10 correctly. In other words, the user information management apparatus 100 determines that the user who has performed the authentication in response to the authentication request at Step S21 is undoubtedly the user U01. The user information management apparatus 100 may acquire, in addition to the signed authentication result, service-specific information such as the description of the service to be used by the user U01, the facility where the service is provided, and the identification information of the facility apparatus 50 deployed in the facility.

The user information management apparatus 100 then generates the identity verification information indicating that identity of the user who is currently carrying the user terminal 10 has been verified as undoubtedly being the user U01 (Step S25). The identity verification information generated by the user information management apparatus 100 includes service-related privilege information. This information is included to indicate that the user information management apparatus 100 has verified the identity of the user U01, that is, verified that the user U01 is a person who has a privilege to receive the service provided at the facility. In other words, the user information management apparatus 100 generates the identity verification information as the information including information indicating that the user U01 is the person who has a privilege to receive the service provided at the facility. The user information management apparatus 100 then transmits the generated identity verification information to the user terminal 10 (Step S26).

The user terminal 10 then performs a process of presenting the received identity verification information to the facility apparatus 50. For example, the user U01 holds the user terminal 10 above a reader unit provided to the facility apparatus 50 (Step S27). The facility apparatus 50 identifies the user terminal 10 via a contactless wireless communication, for example. The facility apparatus 50 then requests the information of the user who is to use the service from the user terminal 10 (Step S28). In other words, the facility apparatus 50 requests information certifying that the user U01 who is currently carrying the user terminal 10 is the user truly having a privilege to receive the service.

The user terminal 10 responds with the identity verification information received from the user information management apparatus 100, in response to the request at Step S28 (Step S29). The facility apparatus 50 validates the identity verification information received from the user terminal 10 (Step S30). For example, the facility apparatus 50 checks whether the specific service to be provided are the same as the service that the user U01 has registered online, for example. As the validation result of the identity verification information, the facility apparatus 50 determines the user U01 as a legitimate user having a privilege to receive the service. The facility apparatus 50 then provides the service to the user U01 (Step S31). Specifically, the facility apparatus 50 admits the user U01 to the concert to be held at the facility.

In this manner, in the user information management system 1, the user information management apparatus 100 acquires the privilege information related to the service to be received by the user U01 of the user terminal 10. The user information management apparatus 100 then receives the result of the authentication for authenticating the identity of the user U01, the authentication being executed on the user terminal 10 before the user receives the service. The user information management apparatus 100 then transmits the identity verification information that is information generated based on the received authentication result, and indicating that the user U01 is a user with the privilege to receive the service.

In other words, the user information management apparatus 100 can verify the identity of the user U01, using the authentication result corresponding to the user U01 executed on the user terminal 10. This means that the user information management apparatus 100 not only authenticates the user U01 who is to use the service online, but also authenticates the user U01 offline (in the real world). In this manner, the facility can identify that the user who is attempting to use the service is the user U01 him/herself. The facility has conventionally needed to prepare a gate or the like having a face authentication function, for example, and to authenticate each user. By contrast, in the embodiment, because the authentication is executed on the user terminal 10, the facility is no longer required to manage the biological information of the user, or to authenticate the user, workloads and costs can be reduced. Furthermore, because the facility can reduce the time required for identity verification, the facility can provide the service more quickly. In the manner described above, with the user information management apparatus 100, information managed online can be used efficiently.

### 4. Configuration of User Information Management Apparatus

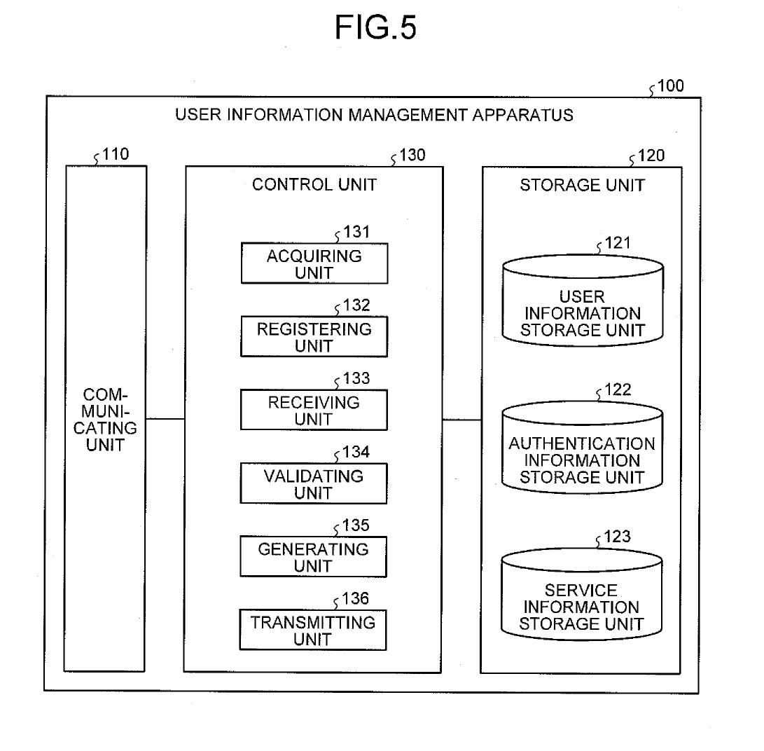

A configuration of the user information management apparatus 100 according to the embodiment will now be explained with reference to FIG. 5. FIG. 5 is a schematic illustrating an exemplary configuration of the user information management apparatus 100 according to the embodiment. As illustrated in FIG. 5, the user information management apparatus 100 includes a communicating unit 110, a storage unit 120, and a control unit 130. The user information management apparatus 100 may also include an input unit (e.g., a keyboard or a mouse) for receiving various types of operations from an administrator or the like of the user information management apparatus 100, and a display unit (e.g., liquid crystal display) for displaying various types of information.

The communicating unit 110 is implemented as a network interface card (NIC), for example. The communicating unit 110 is connected to a network, not illustrated, over the wire or wirelessly, and transmits and receives information to and from the user terminal 10 or the facility apparatus 50 over the network. When the signed authentication result received from the user terminal 10 is processed, the communicating unit 110 may process the signed authentication result in accordance with a certain highly secure authentication procedure (protocol).

The storage unit 120 is implemented as, for example, a storage device such as a random access memory (RAM), a semiconductor memory element such as a flash memory, a hard disk, and an optical disc. The storage unit 120 according to the embodiment includes a user information storage unit 121, an authentication information storage unit 122, and a service information storage unit 123. Each of these storage units will now be explained one by one.

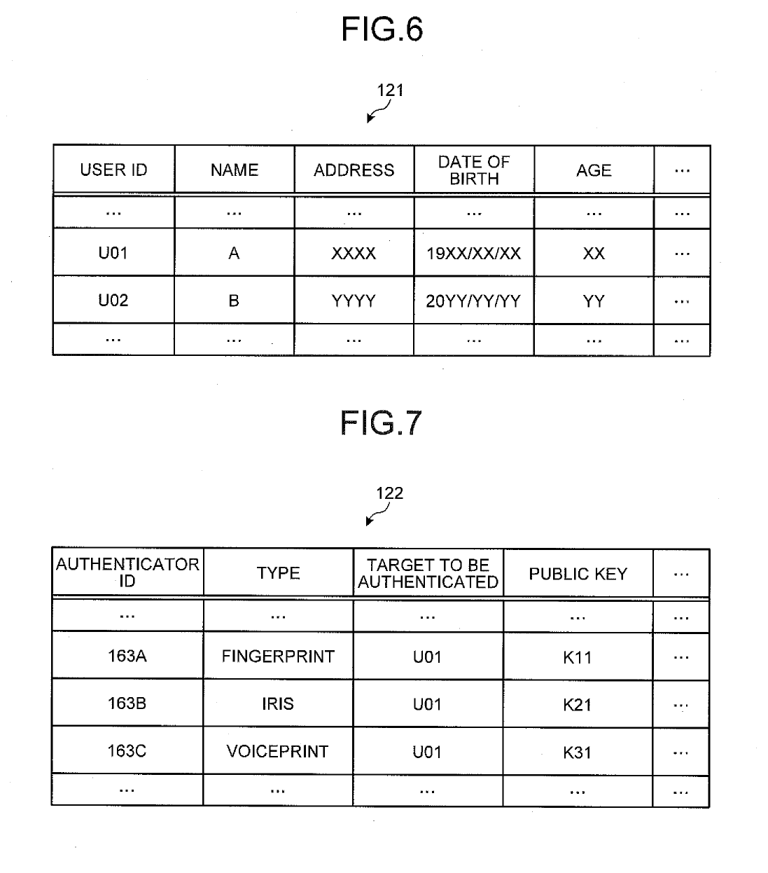

The user information storage unit 121 stores therein information related to users of a service provided at the facility. FIG. 6 illustrates an example of the user information storage unit 121 according to the embodiment. FIG. 6 is a schematic illustrating an example of the user information storage unit 121 according to the embodiment. In the example illustrated in FIG. 6, the user information storage unit 121 includes items such as “user ID,” “name,” “address,” “date of birth,” and “age.”

The “user ID” represents identification information for identifying a user registered in the user information management apparatus 100. The “name” represents the name of the user. The “address” represents the address at which the user resides. The “date of birth” represents the date of birth of the user. The “age” represents the age of the user. The information of these items is illustrated conceptually, and in practice, the item “address” is registered with the name of the prefecture, the city, and the like in which the user resides, for example.

In other words, in the example of the information stored in the user information storage unit 121 illustrated in FIG. 6, the name of the user identified by the user ID “U01” is “A,” the address is “XXXX,” the date of birth is “19 XX,” and the age is “XX.”

The authentication information storage unit 122 stores therein information related to the authentication of the user terminal 10. FIG. 7 illustrates an example of the authentication information storage unit 122 according to the embodiment. FIG. 7 is a schematic illustrating an example of the authentication information storage unit 122 according to the embodiment. In the example illustrated in FIG. 7, the authentication information storage unit 122 includes items such as “authenticator ID,” “type,” “target to be authenticated,” and “public key.”

The “authenticator ID” represents information for identifying the authenticator registered by the user terminal 10 to the user information management apparatus 100. The “type” represents the type of the authentication means executed by the authenticator. The “target to be authenticated” represents the identification information of the user to be authenticated by the authenticator. The identification information indicated in the item “target to be authenticated” is matched with the user ID illustrated in FIG. 6. The “public key” represents the key information received from the authenticator (in other words, from the user terminal 10) when the authenticator is registered, and paired with the secret key issued at the same time. The public key is stored in a manner mapped to the corresponding authenticator and target to be authenticated. In other words, the public key is stored in a manner mapped to a piece of correct answer data for authenticating a user, stored in the user terminal 10.

In other words, in the example of the information stored in the authentication information storage unit 122 illustrated in FIG. 7, registered is the authenticator identified by the authenticator ID “163A”; the type of the authenticator is “fingerprint”; and the user to be authenticated is “U01”; and the public key used by the authenticator in authenticating the user U01 is “K11”

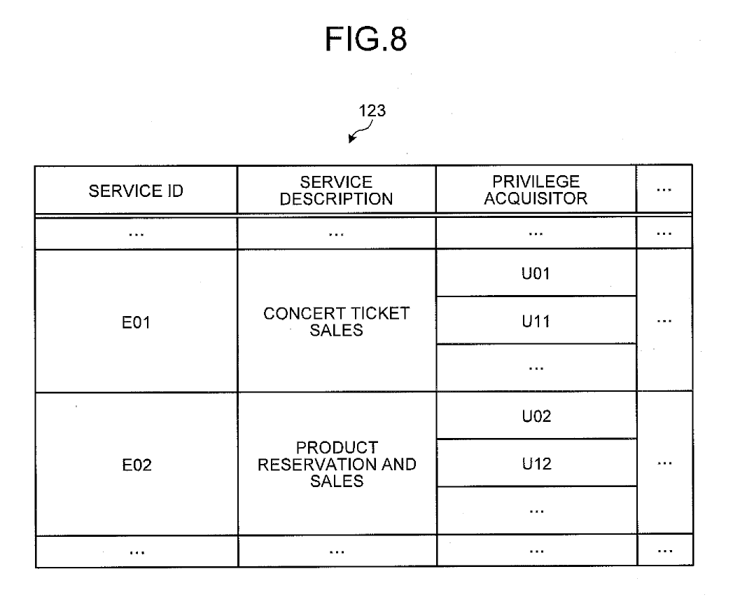

The service information storage unit 123 stores therein information related to the service that is provided at the facility. FIG. 8 illustrates an example of the service information storage unit 123 according to the embodiment. FIG. 8 is a schematic illustrating an example of the service information storage unit 123 according to the embodiment. In the example illustrated in FIG. 8, the service information storage unit 123 includes items such as “service ID,” “service description,” and “privilege acquirer.”

The “service ID” represents identification information for identifying a service provided at the facility. The “service description” represents the description of the service to be provided. The “privilege acquirer” represents the identification information of a user who has acquired a privilege to receive the service. The identification information specified in the item “privilege acquirer” is matched with the user ID illustrated in FIG. 6. The item “privilege acquirer” may also store therein the date and the time at which the privilege is acquired, other privilege-related detailed information, and the like (e.g., the date and the time at which the service is to be held, and the description of the service corresponding to the acquired privilege), as well as the identification information of the user having acquired the privilege.

In other words, in the example of the information stored in the service information storage unit 123 illustrated in FIG. 8, registered is the service identified by the service ID “E01,” the description of the service to be provided is “concert ticket sales,” and the privilege acquirers are users identified by “U01” and “U11.”

The control unit 130 is implemented by causing a central processing unit (CPU), a micro-processing unit (MPU), or the like to execute various types of computer programs (corresponding to an example of the user information management program) stored in a storage device that is internal to the user information management apparatus 100, using a RAM as a working area. The control unit 130 may also be implemented as an integrated circuit such as an application specific integrated circuit (ASIC) or a field programmable gate array (FPGA).

As illustrated in FIG. 5, the control unit 130 includes an acquiring unit 131, a registering unit 132, a receiving unit 133, a validating unit 134, a generating unit 135, and a transmitting unit 136, and implements or executes the function or the action of the information processing explained below. The internal configuration of the control unit 130 is not limited to the configuration illustrated in FIG. 5, and may be another configuration as long as the configuration is enabled to perform the information processing explained below. The connection of the processing units included in the control unit 130 is not limited to that illustrated in FIG. 5, and may be connected in any other configuration.

The acquiring unit 131 acquires various types of information. For example, the acquiring unit 131 acquires information related to the service to be received by the user of the user terminal 10. Specifically, the acquiring unit 131 receives the service-related information from the facility apparatus 50 by communicating with the facility apparatus 50. The acquiring unit 131 then acquires the description of the service to be implemented by the facility apparatus 50, the information related to the user who has a privilege for the service (privilege information), and the like from the facility apparatus 50.

The acquiring unit 131 also acquires information related to the user terminal 10. For example, the acquiring unit 131 acquires the information related to the authenticator used in the authentication executed on the user terminal 10. Specifically, the acquiring unit 131 acquires the type of the authenticator and the information related to the user who is to be authenticated by the authenticator. The acquiring unit 131 also acquires the public key corresponding to the authentication.

The registering unit 132 registers various types of information. For example, the registering unit 132 registers information related to the authenticator included in the user terminal 10, in response to a registration request received from the user terminal 10. Specifically, the registering unit 132 registers the information related to the authenticator acquired by the acquiring unit 131 to the authentication information storage unit 122.

The registering unit 132 registers the public key, among the public key and the secret key that are used as a pair in the authentication executed on the user terminal 10. When the signed authentication result is validated, the validating unit 134 validates the result by referring to the public key registered by the registering unit 132.

The registering unit 132 also receives a registration related to the service from the service provider, that is, from the facility wanting to use the user information management apparatus 100. For example, the registering unit 132 receives a registration of a service for which the identity verification process of the user information management apparatus 100 is to be used, based on the service-related information received from the facility apparatus 50.

The receiving unit 133 receives various types of information. For example, the receiving unit 133 receives the result of the authentication executed on the user terminal 10, from the user terminal 10 wanting the validation (in other words, the identity verification process) of the user information management apparatus 100. Specifically, the receiving unit 133 receives the result of the authentication executed by the user terminal 10 to have the identity of the user authenticated when the user receives a service provided by the facility.

In such a case, the receiving unit 133 receives the authentication result indicating that the authentication has been done using the authentication means (authenticator) registered by the registering unit 132. More specifically, the receiving unit 133 receives the signed authentication result signed with the secret key that is used in the authentication performed by the pre-registered authenticator, as the result of the authentication.

The validating unit 134 validates the signed authentication result. Specifically, the validating unit 134 analyzes the signed authentication result received from the user terminal 10, and identifies the user who is to be authenticated based on the signed authentication result. The validating unit 134 also identifies the secret key corresponding to the authenticator having generated the signed authentication result, by referring to the user information storage unit 121 and the authentication information storage unit 122. The validating unit 134 then validates whether the signature appended to the signed authentication result is a signature generated with the secret key of the registered authenticator, using the public key corresponding to the secret key.

If the signed authentication result is validated by the public key corresponding to the secret key, the validating unit 134 acknowledges the signed authentication result received from the user terminal 10 as being a result of legitimate authentication. In other words, the validating unit 134 acknowledges that the authentication executed on the user terminal 10 has authenticated the pre-registered legitimate user. The validating unit 134 then sends the validation result to the generating unit 135.

The validating unit 134 not only validates the signed authentication result, but also validates the privilege information that the user authenticated by the authentication is granted for the service. For example, by validating the signed authentication result, the validating unit 134 can validate that the user at the time at which the privilege to receive the service has occurred online is the same as the user who is executing the authentication on the user terminal 10 in an attempt to use the service. Through this process, the validating unit 134 acknowledges the user executing the authentication on the user terminal 10 in an attempt to actually use the service as the user who has a privilege to receive the service. The validating unit 134 also sends the privilege information to the generating unit 135.

The validating unit 134 may render the user identity indicated by the signed authentication result unacceptable if the authenticator having generated signed authentication result does not satisfy a predetermined condition. For example, if the authenticator having generated signed authentication result is not registered in the authentication information storage unit 122 managed by the registering unit 132, or if the received signed authentication result does not follow a certain authentication procedure (protocol) imposed by the user information management apparatus 100, the validating unit 134 may consider the user identity indicated by the signed authentication result unacceptable. In such a case, the validating unit 134 sends a notification indicating that a validation error has occurred, because the user identity cannot be verified, to the transmitting unit 136.

The generating unit 135 generates the identity verification info' adorn indicating that the identity of the user who is to receive the service has been verified, based on the information validated by the validating unit 134. For example, the generating unit 135 generates, when the signed authentication result is validated with the public key corresponding to the secret key, the identity verification information related to the user corresponding to the signed authentication result.

The generating unit 135 may include privilege information indicating the privilege to receive the service in the user identity verification information resultant of the authentication. In other words, the generating unit 135 generates information indicating that the user who has placed a predetermined order for the service online is the same user as the user who has executed the authentication near the facility where the service is actually to be provided. By acquiring such information, the facility apparatus 50 can determine that the user who is actually attempting to receive the service at the facility is a qualified user.

The transmitting unit 136 transmits various types of information. For example, the transmitting unit 136 transmits the identity verification information indicating that the identity of the user who is attempting to receive the service has been verified based on the authentication result received by the receiving unit 133. Specifically, the transmitting unit 136 transmits the identity verification information generated by the generating unit 135 when the signed authentication result received by the receiving unit 133 is validated by the validating unit 134 to the user terminal 10.

### 5. Configuration of User Terminal

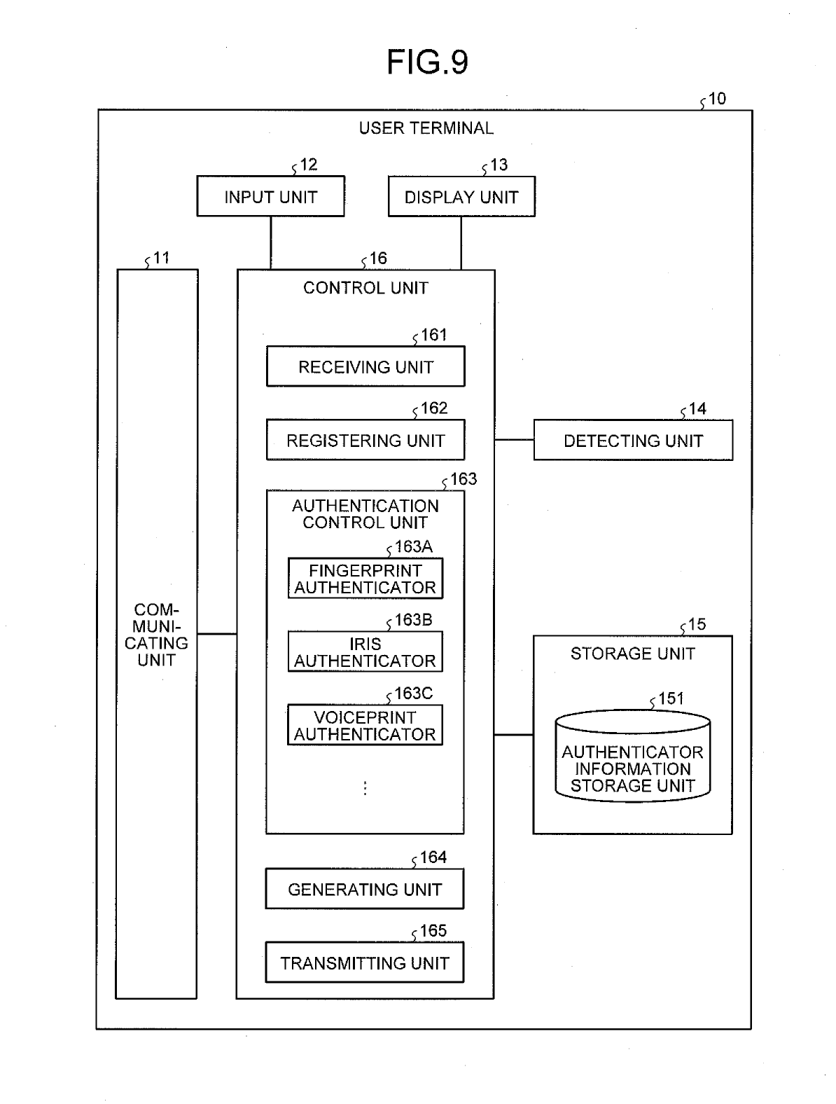

A configuration of the user terminal 10 according to the embodiment will now be explained with reference to FIG. 9. FIG. 9 is a schematic illustrating an exemplary configuration of the user terminal 10 according to the embodiment. As illustrated in FIG. 9, the user terminal 10 includes a communicating unit 11, an input unit 12, a display unit 13, a detecting unit 14, a storage unit 15, and a control unit 16. The connection of the processing units included in the user terminal 10 is not limited to that illustrated in FIG. 9, and may be connected in any other configuration.

The communicating unit 11 is connected to a network over the wire or wirelessly, and transmits and receives information to and from the user information management apparatus 100 or the facility apparatus 50, for example. The communicating unit 11 is implemented as a NIC, for example.

The input unit 12 is an input device that receives various types of operations from the user. For example, the input unit 12 is implemented as an operation key provided to the user terminal 10. The input unit 12 may also include an image capturing device (e.g., camera) for capturing images, or sound collecting device (e.g., microphone) for collecting sound.

The display unit 13 is a display device for displaying various types of information. The display unit 13 is implemented as a liquid crystal display, for example. In a configuration in which the user terminal 10 has a touch panel, a part of the input unit 12 is integrated with the display unit 13.

The detecting unit 14 detects operations performed on the user terminal 10, and the environment around the user terminal 10, for example. Specifically, the detecting unit 14 detects user operations performed on the user terminal 10, and also detects information of the position at which the user terminal 10 is located, and information related to the device connected to the user terminal 10. The detecting unit 14 may detect these pieces of information using various sensors provided to the user terminal 10, for example.

The storage unit 15 stores therein various types of information. The storage unit 15 is implemented as a storage device such as a RAM, a semiconductor memory element such as a flash memory, a hard disk, or an optical disc. The storage unit 15 includes an authenticator information storage unit 151.

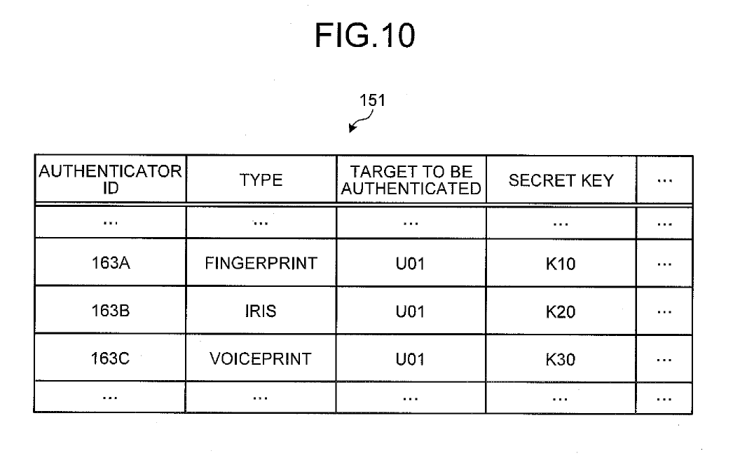

The authenticator information storage unit 151 stores therein information related to authenticators. FIG. 10 is a schematic illustrating an example of the authenticator information storage unit 151 according to the embodiment. In the example illustrated in FIG. 10, the authenticator information storage unit 151 includes items such as “authenticator ID,” “type,” “target to be authenticated,” and “secret key.”

The “authenticator ID” represents identification information for identifying an authenticator. In the embodiment, the reference numerals denoting the respective authenticators are matched with the authenticator IDs. For example, the authenticator represented by the authenticator ID “163A” represents a fingerprint authenticator 163A.

The “type” represents the type of the authentication scheme run by the authenticator. Examples of the type include fingerprint, iris, and voiceprint. The authentication scheme of the authenticator is not limited to those listed above. For example, the authenticator may be a facial authenticator authenticating a user using image data of the face of the user, or biometric information authenticator that detects the heartbeat of the user with a sensor, for example. The authentication schemes used by the authenticator are not limited to those using biological information. For example, the authenticator may be a hardware authenticator that authenticates the user by causing the user U01 to connect a predetermined physical key owned by the user to the user terminal 10, or may be a subscriber identity module (SIM) card authenticator that authenticates by determining the content of the SIM card internalized in the user terminal 10. The authenticator may also use a scheme performing authentication using the personal identification number (PIN) assigned to the user terminal 10 itself.

The “target to be authenticated” represents the user to be authenticated by the authenticator. The “secret key” represents a key with which the authentication result from the authenticator is signed, and with which a signed authentication result is generated. The public key to be paired with the secret key is issued at the time when the authenticator is registered to the user information management apparatus 100. The secret key is retained in the user terminal 10. The secret key is retained in an area to which no access is permitted unless the user is successfully authenticated by the corresponding authenticator. The public key is transmitted by the user terminal 10 to the user information management apparatus 100.

In other words, in the example illustrated in FIG. 10, the authenticator identified by the authenticator ID “163A” (the fingerprint authenticator 163A) is mapped to an authentication type “fingerprint,” and the user to be authenticated “the user U01,” and a secret key “K10.”

The control unit 16 is implemented by causing a CPU or the like to execute various computer programs stored in a storage device that is internal to the user terminal 10, using the RAM as a working area. The control unit 16 may also be implemented as an integrated circuit such as an ASIC or an FPGA.

The control unit 16 controls various types of processes such as the local authentication executed on the user terminal 10, the process of causing the authenticator to function, and the process of exchanging information with the facility apparatus 50 or the user information management apparatus 100. As illustrated in FIG. 9, the control unit 16 includes a receiving unit 161, a registering unit 162, an authentication control unit 163, a generating unit 164, and a transmitting unit 165, and implements or executes the function or the action of the information processing explained below. For example, the control unit 16 implements various types of information processing by executing computer programs such as applications installed on the user terminal 10, using a RAM as a working area. The internal configuration of the control unit 16 is not limited to the configuration illustrated in FIG. 9, may be another configuration as long as the configuration is enabled to perform the information processing explained below.

The receiving unit 161 receives various types of information. The receiving unit 161 receives information transmitted by the user information management apparatus 100 or the facility apparatus 50, for example.

The receiving unit 161 receives the information transmitted by a predetermined device deployed in the facility when the user is to actually receive the service at the facility. Examples of the predetermined device include the facility apparatus 50, an access point, and a beacon deployed at the facility. The receiving unit 161 receives an authentication request transmitted by these types of device. The receiving unit 161 sends the received information to the authentication control unit 163, for example, and causes the unit to execute the corresponding process.

The receiving unit 161 also receives the identity verification information transmitted by the user information management apparatus 100. The receiving unit 161 also receives, when the identity verification information is presented to the facility, information via a near field radio communication established with the facility apparatus 50. The receiving unit 161 may also receive various types of information detected by the detecting unit 14.

The registering unit 162 registers various types of information related to authentication. The registering unit 162 also registers predetermined information related to the authentication to the user information management apparatus 100. Registrations herein include causing the user information management apparatus 100 to register some information to itself in response to an instruction of the registering unit 162.

For example, the registering unit 162 registers information related to the authenticator that authenticates the identity of the user who is using the user terminal 10 to the authenticator information storage unit 151. The registering unit 162 also registers the authenticator included in the user terminal 10 to the user information management apparatus 100 so that user terminal 10 can have its authentication validated by the user information management apparatus 100. In the registration, the registering unit 162 registers the secret key corresponding to the authentication to the authenticator information storage unit 151. The registering unit 162 also transmits the public key to be used in validating the signature having been generated with a secret key corresponding thereto to the user information management apparatus 100, and registers the public key to the user information management apparatus 100.

The authentication control unit 163 controls the process related to the authentication of the identity of the user who is using the user terminal 10. For example, the authentication control unit 163 manages the authenticator included in the user terminal 10. The authentication control unit 163 causes the authenticator having been registered by the registering unit 162 to operate, and authenticates the identity of the user who is using the user terminal 10. In other words, in the embodiment, the authentication control unit 163 implements the function of the authenticator such as the fingerprint authenticator 163A, an iris authenticator 163B and a voice authenticator 163C.

The generating unit 164 controls generation of a signed authentication result. The generating unit 164 acquires the result of the authentication caused to be executed by the authentication control unit 163 and received from the authenticator. The generating unit 164 then generates the signed authentication result by signing the authentication result using the secret key.

For example, assuming that the authentication control unit 163 authenticates the user U01 using the fingerprint authenticator 163A illustrated in FIG. 10, the generating unit 164 generates the signed authentication result by signing the authentication result with the secret key K10. Such a signed authentication result indicates that the fingerprint authenticator 163A has completed the identity authentication for the user U01 on the user terminal 10. The generating unit 164 sends the generated signed authentication result to the transmitting unit 165, and causes the transmitting unit 165 to transmit the result to the user information management apparatus 100.

The transmitting unit 165 transmits various types of information. For example, the transmitting unit 165 transmits the signed authentication result generated by the generating unit 164 to the user information management apparatus 100. The transmitting unit 165 may transmit information requested by the facility apparatus 50, after the communication is established with the facility apparatus 50. The transmitting unit 165 transmits, for example, when the identity verification information transmitted by the user information management apparatus 100 is received, the identity verification information to the facility apparatus 50.

### 6. Configuration of Facility Apparatus

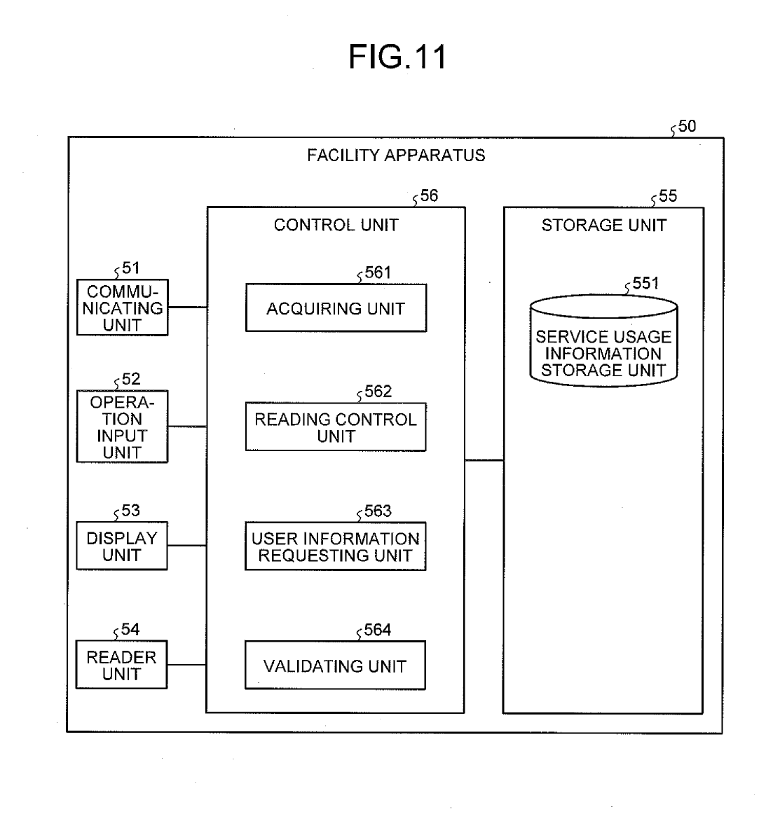

A configuration of the facility apparatus 50 will now be explained. FIG. 11 is a schematic illustrating an exemplary configuration of the facility apparatus according to the embodiment. As illustrated in FIG. 11, the facility apparatus 50 includes a communicating unit 51, an operation input unit 52, a display unit 53, a reader unit 54, a storage unit 55, and a control unit 56.

The communicating unit 51 is an interface such as a NIC. The communicating unit 51 exchanges various types of data with other apparatuses over the network. For example, the communicating unit 51 transmits information related to the service provided by the facility apparatus 50 to the user information management apparatus 100. The communicating unit 51 also transmits an authentication request to the user terminal 10.

The operation input unit 52 is an input device for inputting various types of information. Examples of the operation input unit 52 include input devices such as a mouse, a keyboard, and a touch panel. The operation input unit 52 receives inputs of various types of information from an administrator of the facility apparatus 50, for example (e.g., a clerk working at the facility), and inputs of operation information representing the details of input operations to the control unit 56.

The display unit 53 is a display device for displaying various types of information. Examples of the display unit 53 include display devices such as a liquid crystal display (LCD) and a cathode ray tube (CRT). The display unit 53 displays various types of information. The display unit 53 displays, for example, whether the user satisfies the condition for receiving the service.

The reader unit 54 reads predetermined information. For example, when the user terminal 10 is held above the reader unit 54, the reader unit 54 initiates a near field radio communication function included in the user terminal 10. The reader unit 54 then reads the identity verification information that the user terminal 10 has received from the user information management apparatus 100. The means by which the reader unit 54 reads the information may be implemented using various types of known reading means. For example, the reader unit 54 may read a two dimensional code in which the identity verification information is coded as an image, decode the coded the identity verification information, and output the information to the control unit 56.

The storage unit 55 is a device for storing therein various types of information. Examples of the storage unit 55 include storage devices such as a RAM, a semiconductor memory element such as a flash memory, a hard disk, and an optical disc.

The storage unit 55 stores therein the operating system (OS) executed by the control unit 56, and various types of computer programs used in managing the user information. The storage unit 55 also stores therein various types of data. For example, the storage unit 55 includes a service usage information storage unit 551.

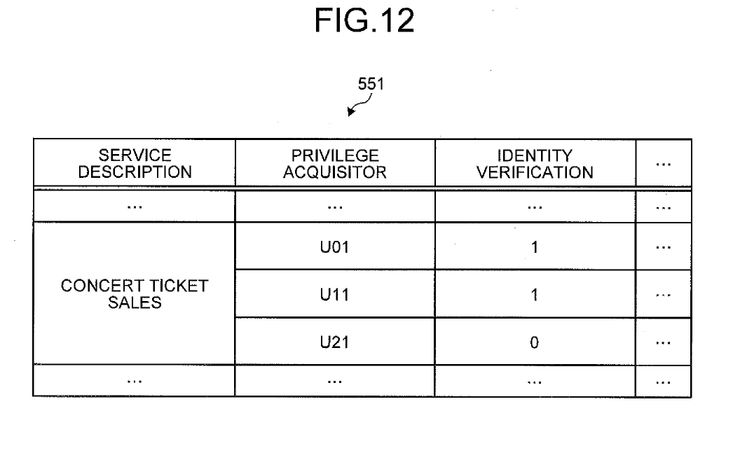

The service usage information storage unit 551 stores therein information related to usage of the service provided at the facility. FIG. 12 illustrates an example of the service usage information storage unit 551 according to the embodiment. FIG. 12 is a schematic illustrating an example of the service usage information storage unit 551 according to the embodiment. In the example illustrated in FIG. 12, the service usage information storage unit 551 includes items such as “service description,” “privilege acquirer,” and “identity verification.”

The “service description” corresponds to the same item as that explained in FIG. 8. The “privilege acquirer” is identification information for identifying the user who has made an online purchase of a right for using the service. For example, when the service description specifies a service as concert ticket sales, the user who has purchased the right for using the service is the user who has already made an online payment for the concert ticket. In other words, the privilege acquirer is a user having a privilege to receive the service.

The “identity verification” is information representing whether the identity of the user who has made the online purchase of the service has been verified in the real world. For example, if the identity verification specifies “1,” it represents that the identity of the user has been verified. If the identity verification specifies “0,” it represents the identity of the user has not been verified yet. The identity verification is rendered completed when the facility apparatus 50 validates the identity verification information received from the user information management apparatus 100, and completes the validation, for example.

In other words, the example of the information stored in FIG. 12, the service usage information storage unit 551, the description of the service to be provided by the facility apparatus 50 is “concert ticket sales,” the privilege acquirers are users identified by “U01,” “U11,” and “U21,” and the identify verification has been completed for “U01” and “U11.”

The control unit 56 is a device for controlling the facility apparatus 50. An electronic circuit, such as a CPU or an MPU, or an integrated circuit such as an ASIC or an FPGA, for example, may be used as the control unit 56. The control unit 56 has an internal memory for storing therein computer programs specifying various processes, and control data, and executes various processes using such computer programs. The control unit 56 serves as various processing units by causing the various computer programs to operate. For example, the control unit 56 includes an acquiring unit 561, a reading control unit 562, a user information requesting unit 563, and a validating unit 564.

The acquiring unit 561 acquires various types of information. For example, the acquiring unit 561 acquires information related to usage of online services. In such a case, the acquiring unit 561 may acquire information representing that a service has been used from a web server or the like managing a web site related to the service provided by the facility, for example.

The reading control unit 562 controls a reading process performed by the reader unit 54. For example, the reading control unit 562 reads the user terminal 10 by controlling the reader unit 54, when a predetermined operation for instructing reading the user terminal 10 is performed on the operation input unit 52.

The user information requesting unit 563 controls predetermined requests related to the users using the facility. For example, the user information requesting unit 563 controls an access point or a beacon deployed in the facility, and causes the access point or the beacon to establish a communication for requesting the user authentication with the user terminal 10. Alternatively, the user information requesting unit 563 itself may transmit a request for the authentication to the user terminal 10, without using the access point or the beacon.

The validating unit 564 validates, when identity verification information is acquired from the user information management apparatus 100, the acquired identity verification information. The validating unit 564 validates, for example, whether the user who has had his/her identity verified by the user information management apparatus 100 truly has the privilege related to the service to be provided, for example. The validating unit 564 may then cause the display unit 53 to display whether the user satisfies the condition for receiving the service, based on the validation result.

The validating unit 564 may validate whether the service to be provided to the user is appropriate based on the user information, when such user information is included in the identity verification information. For example, the validating unit 564 may validate whether it is appropriate to provide the service to the user, depending on the age of the user stored in the user information storage unit 121, when the target age is specified in the service to be provided. Specifically, when the facility is a facility selling alcohol or cigarettes, the facility apparatus 50 may require the user who is carrying the user terminal 10 to execute the identity verification process at the facility before actually passing the product to the user who has acquired the privilege to receive the product through the online authentication. By causing the user information management apparatus 100 to determine whether the user is at the age permitted to purchase alcohol or cigarettes, the validating unit 564 can validate that the user is an appropriate user for receiving the service.

### 7. Procedure of Process

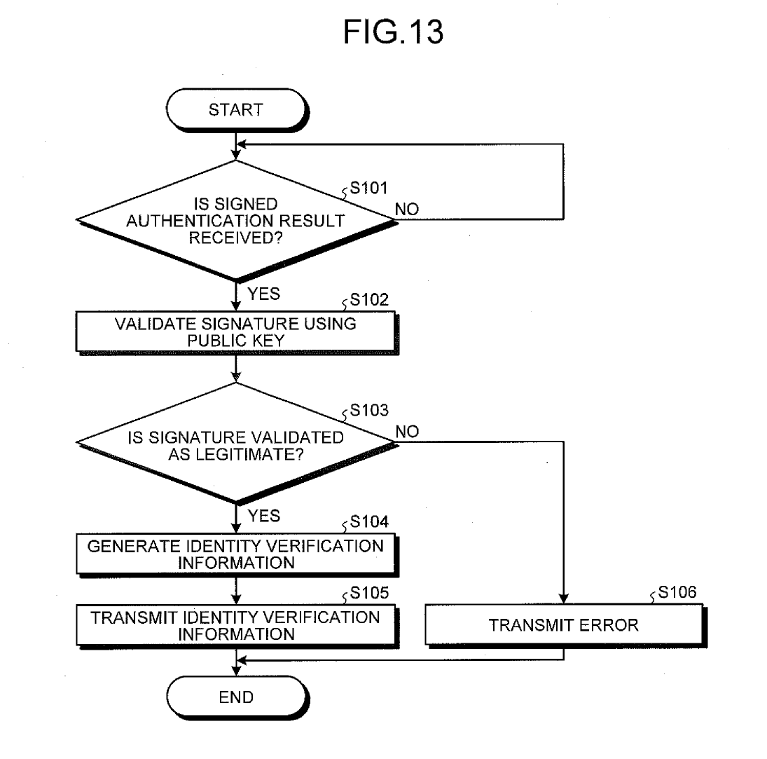

The process performed by the user information management apparatus 100 will now be explained with reference to FIG. 13. FIG. 13 is a flowchart illustrating the procedure of the process according to the embodiment.

To begin with, the receiving unit 133 in the user information management apparatus 100 determines whether a signed authentication result has been received from the user terminal 10 (Step S101). If the signed authentication result has not been received, the receiving unit 133 waits until it is received (No at Step S101).

If the signed authentication result has been received (Yes at Step S101), the validating unit 134 validates the signature using the public key corresponding to the signature (Step S102). The validating unit 134 then determines whether the signature is validated as being a legitimate signature (Step S103). If the signature has been validated as being a legitimate signature (Yes at Step S103), the generating unit 135 generates the identity verification information (Step S104). The transmitting unit 136 then transmits the generated identity verification information to the user terminal 10, which is the source from which the signed authentication result has been transmitted (Step S105).

If the signature is not validated as being a legitimate signature (No at Step S103), the transmitting unit 136 transmits an error indicating that validation of the authentication executed on the user terminal 10 has failed to the user terminal 10 (Step S106).

### 8. Modifications

The user information management process performed by the user information management system 1 may be implemented in various embodiments, in addition to the embodiment described above. Therefore, other embodiments of the user information management system 1 will now be explained.

### 8-1. Sequence of Process

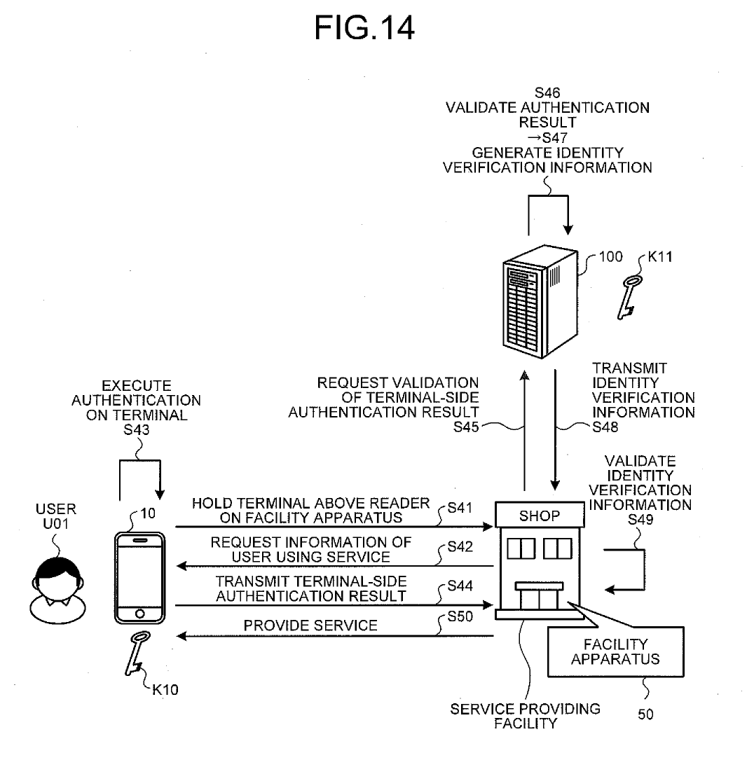

In the process explained in the embodiment, the identity verification information generated by the user information management apparatus 100 is transmitted to the user terminal 10. However, the user information management system 1 may exchange the identity verification information using a process other than that explained in the embodiment. This point will now be explained with reference to FIG. 14.

FIG. 14 is a schematic illustrating an example of a user information management process according to a modification. The example illustrated in FIG. 14, the identity verification information that is the result of validating the authentication executed on the user terminal 10 is transmitted from the user information management apparatus 100 to the facility apparatus 50.

For example, it is assumed herein that the user U01 who is using the user terminal 10 has already placed an online order for the service provided by the service-providing facility (that is a store having a real store that sells a product reserved online, in the example illustrated in FIG. 14). The user U01 then visits the store to receive the product.

The user U01 having visited the store requests the service. In the example illustrated in FIG. 14, the user U01 holds the user terminal 10 above the reader unit 54 provided to the facility apparatus 50 (Step S41). The facility apparatus 50 then reads the information retained in the user terminal 10 via the reader unit 54. For example, the facility apparatus 50 reads the information indicating that the product has been ordered in advance via the user terminal 10, and that the user terminal 10 is requesting the service of receiving the product. In response, the facility apparatus 50 determines that the user should be checked as to whether the user U01 who is actually in the store is truly the user who has placed the order for the product. The facility apparatus 50 therefore requests information of the user U01 who is attempting to use the service (Step S42).

In response to the request at Step S42, the user U01 executes the authentication on the user terminal 10 (Step S43). In other words, the user terminal 10 executes the authentication of the user U01 using the authenticator registered in advance to the user information management apparatus 100. If the authentication succeeds, the user terminal 10 transmits the result of the authentication executed on the user terminal 10 to the facility apparatus 50 (Step S44). In other words, the user terminal 10 transmits the signed authentication result, having been signed with the secret key K10, to the facility apparatus 50.

The facility apparatus 50 then requests the user information management apparatus 100 to validate the authentication result acquired from the user terminal 10 (Step S45). In other words, the facility apparatus 50 transmits the signed authentication result acquired from the user terminal 10 to the user information management apparatus 100. The user information management apparatus 100 then validates the received authentication result (Step S46). Specifically, the user information management apparatus 100 validates the signature using the public key K11 corresponding to the secret key K10. If the validation is completed with no problem, the user information management apparatus 100 generates the identity verification information related to the user U01 (Step S47).

The user information management apparatus 100 then transmits the generated identity verification information to the facility apparatus 50 (Step S48). The facility apparatus 50 then validates the acquired identity verification information (Step S49). If the validation is completed with no problem, the facility apparatus 50 provides the service to the user U01 who has been certified to be the user him/herself (Step S50). Specifically, the facility apparatus 50 passes the product that the user U01 has purchased online to the user U01.

In the manner described above, in the user information management system 1, the identity verification information may be exchanged between the facility apparatus 50 and the user information management apparatus 100. In other words, because, in the user information management system 1, the identity of the user of the user terminal 10 can be verified by causing the user information management apparatus 100 to validate the authentication executed on the user terminal 10, the exchange of information between these steps can be changed flexibly. In other words, the user information management apparatus 100 may transmit the identity verification information to the user terminal 10 that transmits the identity verification information to the facility apparatus 50, or may transmit the identity verification information directly to the facility apparatus 50. In this manner, because the user information management apparatus 100 can verify the identity of the user of the user terminal 10 flexibly following different processes, information managed online can be used efficiently.

### 8-2. Implementation of Each Device

The user terminal 10 according to the embodiment may be implemented using different types of devices having a communicating function. Such examples of the user terminal 10 include wearable devices that are information processing terminals such as smart glasses or a smart watch, a television, smart appliances such as a refrigerator or a vacuum cleaner, a smart vehicle such as an automobile, a drone, and a domestic robot.

The user information management apparatus 100 may also have a function for accepting a procedure related to various types of services online. For example, the user information management apparatus 100 may have a function of a web server, and accept some procedure related to various types of services transmitted by a user online, by cooperating with a certain web server. In such a configuration, before the user information management apparatus 100 accepts the service, the user information management apparatus 100 requests the user identity authentication from the user terminal 10, and performs the identity verification process.

Furthermore, the predetermined device deployed in the facility and prompting the user terminal 10 to perform authentication before the service is provided is not limited to an access point or a beacon. For example, the device deployed in the facility may be any information processing terminal capable of generating a communication for prompting the user terminal 10 to perform authentication. The device deployed in the facility may prompt the user to perform the authentication by detecting the presence of the user terminal 10 within a predetermined range in which the device is capable of establishing a communication. In such a case, the user terminal 10 and the device deployed in the facility may both perform the process of detecting the presence of one within a range from the other, using the position information acquired using a global positioning system (GPS) or the like implemented in the respective devices. Furthermore, the device deployed in the facility may prompt the user terminal 10 to perform the authentication depending on the time remaining before the service is provided. For example, the device deployed in the facility may prompt the user terminal 10 to perform the authentication so that the user identity verification process for the user of the user terminal 10 is completed at the timing at which only one hour is remaining until the time when the service is provided.

Furthermore, the near field communication established between the user terminal 10 and the facility apparatus 50 may be based on the near field radio communication established in accordance with Near Field radio Communication (NFC), for example. Alternatively, the near field communication may also be established by exchanging sonic waves, or by means of direct connection between these devices. In such a configuration, the receiving unit 133 in the user information management apparatus 100 receives the result of the authentication executed by the user terminal 10, being executed in response to a request for presenting information indicating the ownership of a privilege issued by the facility apparatus 50 that is managed by the provider who provides the service, or issued by the predetermined device deployed in the facility where the service is provided, via some near field communication. In other words, the user terminal 10 performs the authentication related to the privilege having been acquired online, at a position where a near field communication with the facility can be detected, instead of via a wide area network. In this manner, the privilege can be validated highly securely, because the facility can authenticate the user identity after the facility confirms the presence of the user terminal 10.

### 8-3. Configuration of Each Device

In the embodiment described above, exemplary configurations of the user terminal 10, the facility apparatus 50, and the user information management apparatus 100 are explained with reference to FIGS. 5, 9, and 11, respectively. However, the devices included in the user information management system 1 do not necessarily need to be implemented in the configurations illustrated in these examples. For example, the user terminal 10 does not need to include all of the processing units illustrated in the example of FIG. 9. In other words, the user terminal 10 does not necessarily need to include the display unit 13 or the detecting unit 14. The user terminal 10 may be divided into two or more devices to achieve the configuration illustrated in FIG. 9. For example, the user terminal 10 may be implemented as two or more devices including an authentication device at least including the detecting unit 14, the authentication control unit 163, and the generating unit 164, and a separately provided communication device at least including the communicating unit 11.

### 8-4. Assignment of Privilege

Explained in the embodiment is an example in which the user who attempts to use the service online is the same person as the user who attempts to use the service at the real-world facility. However, the user information management apparatus 100 may also accept an assignment of the privilege, being assigned from a user who uses the service online to another user who wishes to use the service at the real-world facility. In such a case, the user information management apparatus 100 receives the assignment of the privilege from the user who has originally owned the privilege, as well as a registration of the authenticator from the user who is to be the assignee. When the assignee user is to receive the service at the facility, the user information management apparatus 100 requests the result of authentication from the terminal device of the assignee user. The user information management apparatus 100 then performs the identity verification process related to the assignee user. In this manner, the service provider can verify, for the user for whom the procedure of the privilege assignment has been completed online, that the user who has visited the facility is really the user who is the assignee of the privilege him/herself.

### 8-5. Use of Context

When the user terminal 10 is to be authenticated in the embodiment, the user information management apparatus 100 may acquire usage-related information that is detected by the user terminal 10, that is, context information of the user terminal 10. Examples of the context information acquired from the user terminal 10 include time information or position information when or where the authentication is performed.

In the authentication of the user terminal 10, the user information management apparatus 100 may validate the appropriateness of the context information acquired from the user terminal 10. For example, the user information management apparatus 100 may receive the context information of the user terminal 10, as well as the signed authentication result, from the user terminal 10 at Step S23 illustrated in FIG. 4, for example. The user information management apparatus 100 then makes validations as to whether the local authentication on the user terminal 10 has been executed within a predetermined range from the service-providing facility, or has been executed within a predetermined time from when the service is started. In such a case, if the local authentication on the user terminal 10 has been executed at a position far away from the service-providing facility, or executed many days previous to the time at which the service is provided, for example, the user information management apparatus 100 may determine the authentication as illegitimate, and not accept the signed authentication result.

In this manner, the user information management apparatus 100 can validate the result of the authentication executed on the user terminal 10 based on the offline (real-world) condition where the user is actually attempting to use the facility. For example, the user information management apparatus 100 may handle only the result of the authentication executed at the timing or at the location required by the service-providing facility, as a valid authentication result. By validating the context information of the user terminal 10 executing the authentication in the manner described above, the user information management apparatus 100 can improve the accuracy of the verification process of the identity of the user who is executing the authentication.

By performing the authentication using an offline condition around the user terminal 10 or the user, including the fact that the user has visited the facility or the timing at which the user attempts to use the service, as one factor, the user information management apparatus 100 can use the result of the online authentication as the information serving as the offline (real-world) identity verification.

### 9. Hardware Configuration

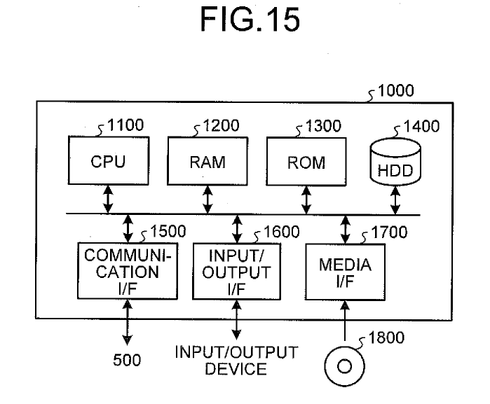

Each of the user terminal 10, the facility apparatus 50, and the user information management apparatus 100 according to the embodiment described above is implemented as a computer 1000 having a configuration illustrated as an example in FIG. 15. In explaining the hardware configuration below, the user information management apparatus 100 will be used as an example. FIG. 15 is a schematic illustrating an exemplary hardware configuration of a computer 1000 implementing the functions of the user information management apparatus 100. The computer 1000 includes a CPU 1100, a RAM 1200, a read-only memory (ROM) 1300, a hard disk drive (HDD) 1400, a communication interface (I/F) 1500, an input/output I/F 1600, and a media I/F 1700.

The CPU 1100 is caused to operate and to control the units by a computer program stored in the ROM. 1300 or the HDD 1400. The ROM 1300 stores therein a boot program executed by the CPU 1100 to start the computer 1000, and computer programs that are dependent on the hardware of the computer 1000, for example.

The HDD 1400 stores therein the computer programs executed by the CPU 1100, and data used by the computer programs, for example. The communication I/F 1500 receives data from other devices over a communication network 500 (corresponding to the network in the embodiment), forwards the data to the CPU 1100, and transmits data generated by the CPU 1100 to the other devices over the communication network 500.

The CPU 1100 controls output devices such as a display and a printer, and input devices such as a keyboard or a mouse via the input/output I/F 1600. The CPU 1100 acquires data from the input device via the input/output I/F 1600. The CPU 1100 outputs generated data to the output device via the input/output I/F 1600.

The media I/F 1700 reads the computer program or the data stored in a storage medium 1800, and provides the computer program or the data to the CPU 1100 via the RAM 1200. (As used herein, the term “storage medium” is not intended to encompass transitory signals.) The CPU 1100 loads a computer program from the storage medium 1800 onto the RAM 1200 via the media I/F 1700, and executes the loaded computer program. Examples of the storage medium 1800 include optical storage media such as a digital versatile disc (DVD) and a phase change rewritable disk (PD), a magneto-optical storage medium such as a magneto-optical (MO) disk, a tape medium, a magnetic storage medium, and a semiconductor memory.

To cause the computer 1000 to function as the user information management apparatus 100 according to the embodiment, for example, the CPU 1100 in the computer 1000 implements the function of the control unit 130 by executing a computer program loaded onto the RAM 1200. The data in the storage unit 120 is stored in the HDD 1400. The CPU 1100 in the computer 1000 reads the computer program from the storage medium 1800 before executing the computer program, but may also acquire the computer program from another device over the communication network 500, as another example.

### 10. Others

Among those processes explained in the embodiments, the whole or a part of the processes explained to be automatically executed may also be manually executed, and the whole or a part of the processes explained to be manually performed may be automatically performed using any known methods. In addition, the procedures of processes, specific names, and information including various types of data and parameters, for example, may be modified in any way, unless specified otherwise. For example, the information illustrated in the drawings is not limited to that illustrated.

The elements included in the apparatuses illustrated in the drawings are schematic representations for depicting their functionality, and are not necessarily need to be physically configured in the manner illustrated in the drawings. In other words, specific configurations in which the devices are distributed or integrated are not limited to those illustrated, and the whole or a part of the apparatuses may be distributed or integrated functionally or physically in any units depending on various loads or utilization. For example, the acquiring unit 131 illustrated in FIG. 5 may be integrated with the registering unit 132. As another example, the information stored in the storage unit 120 may be stored in an external storage device over a network.

Furthermore, the embodiment and modifications described above may be combined as appropriate within the scope in which the processes do not contract one another.

### 11. Advantageous Effects

As described above, the user information management apparatus 100 according to the embodiment includes the acquiring unit 131, the receiving unit 133, and the transmitting unit 136. The acquiring unit 131 acquires the privilege information related to a service that is to be received by the user U01 of the user terminal 10. The receiving unit 133 receives the result of authentication authenticating the identity of the user U01 and executed on the user terminal 10 before the user receives the service. The transmitting unit 136 transmits identity verification information that is information generated based on the authentication result received by the receiving unit 133, and indicating that the user U01 is a user who has a privilege to receive the service.

In this manner, the user information management apparatus 100 according to the embodiment verifies the identity of the user U01 using the result of the authentication executed for the user U01 on the user terminal 10. In this manner, the user information management apparatus 100 can not only authenticate the user U01 who has used the service online, but also verify the identity of the user U01 offline (in the real world). Because the identity verification information is transmitted from the user information management apparatus 100, the facility providing the service can omit burdens such as retaining the information for authenticating users and verifying the user identities. In other words, with the user information management apparatus 100, the information managed online can be used efficiently. For example, the information related to a service provided online can be used effectively in the real world as well.

Furthermore, the user information management apparatus 100 according to the embodiment further includes the registering unit 132 that receives a registration of an authenticator used in the authentication executed on the user terminal 10. The receiving unit 133 receives the authentication result indicating that the user has been authenticated by the authenticator registered by the registering unit 132.

In this manner, the user information management apparatus 100 according to the embodiment can ensure that the user terminal 10 has authenticated the user with a reliable authenticator. For example, by only permitting the registrations of authenticators authenticating with biological information of users, the user information management apparatus 100 can improve the authentication accuracy.

Furthermore, the registering unit 132 receives a registration of a first key corresponding to the authenticator (for example, a public key) in the registration of the authenticator. The receiving unit 133 receives a signed authentication result that is the result of the authentication executed by the authenticator and signed with a second key corresponding to the first key (for example, the secret key corresponding to the public key), as the authentication result. The transmitting unit 136 then transmits the identity verification information when the signed authentication result is successfully validated with the first key.

In this manner, the user information management apparatus 100 according to the embodiment may use a validation scheme that is based on what is called a public key encryption in which credibility of information is ensured by matching a public key against a secret key issued as a pair in advance, in the process of validating the authentication. In this manner, the user information management apparatus 100 can remove spoofing or the like by any third party attempting to make an illegitimate use of the service, for example, because the validation accuracy of the authentication can be improved.

Furthermore, the receiving unit 133 receives the result of the authentication executed by the user terminal 10, the authentication being executed in response to a request for presenting information indicating the ownership of the privilege, the request being transmitted from the facility apparatus 50 managed by the provider who provides the service (an example of a service providing device), or from the predetermined device deployed in the facility where the service is provided via some near field communication.

In other words, the user information management apparatus 100 according to the embodiment receives the result of the authentication that is triggered by a detection of a near field communication by the user terminal 10 that is carried by the user U01 who has actually visited the facility. This means that the authentication executed on the user terminal 10 is executed in response to a request transmitted from the facility where the service is actually provided, instead of being executed over a wide area network, for example. In this manner, because the user information management apparatus 100 can exclude any authentications other than those executed in response to requests issued by the facility where the service is actually provided, and can validate only the authentication really needing such validation, the user information management apparatus 100 can perform the process efficiently.

Furthermore, the transmitting unit 136 transmits the identity verification information that corresponds to the result of the authentication executed in response to the request to the user terminal 10 that transmits the identity verification information that is based on the authentication result to the facility apparatus 50, or transmits the identity verification information to the facility apparatus 50.

In this manner, the user information management apparatus 100 according to the embodiment can transmit the information verifying the identity of the user U01, that is, the information certifying that the user U01 is the user who receives the service to the user terminal 10, or to the facility apparatus 50. When the identity verification information is received from the user information management apparatus 100, the user terminal 10 transmits the identity verification information to the facility apparatus 50 via a near field communication, for example. In this manner, the user information management apparatus 100 can flexibly select the receiver to which the information certifying the privilege of the user U01 is transmitted. This means that the sequence of the process executed in the user information management system 1 can be modified flexibly. In this manner, because the user information management apparatus 100 according to the embodiment can certify the privilege granted to the user U01 of the user terminal 10 following a process performed at a different sequence, the information managed online can be used flexibly.

Furthermore, the receiving unit 133 receives the result of the authentication that is executed by the user terminal 10 in response to a request transmitted from the facility apparatus 50 or from the predetermined device, such a request being transmitted when the user terminal 10 becomes located within a predetermined range from the facility.

In this manner, the user information management apparatus 100 according to the embodiment may generate the identity verification information based on the result of the authentication that is executed in response to a request transmitted based on the position information of the user terminal 10. Because this allows the user information management apparatus 100 to generate the identity verification information at the timing at which the user terminal 10 is to actually receive the service, the user information management apparatus 100 can perform the process efficiently.

Furthermore, the receiving unit 133 receives the result of the authentication executed by the user terminal 10 in response to a request transmitted from at least one of an information processing terminal, an access point, and a beacon that are deployed at the facility where the service is provided.

In this manner, the user information management apparatus 100 according to the embodiment may generate the identity verification information based on the result of the authentication performed in response to a request received from a device of a different type deployed at the facility. In other words, the user information management apparatus 100 can flexibly support different configurations in which the user terminal 10 detects a communication. In this manner, the user information management apparatus 100 can use the information managed online efficiently.

Some embodiments are explained above in detail with reference to some drawings, but these embodiments are merely exemplary, other embodiments may be implemented in any other configurations, with different modifications and improvement applied based on the knowledge of those skilled in the art, in addition to those according to the embodiment described above.

Furthermore, the teen “part (section, module, or unit)” can be replaced with tell is such as “means” or “circuit.” For example, the term “generating unit” may be replaced with terms such as “generating means” and “generating circuit.”

According to one aspect of the embodiment, information managed online can be used efficiently, advantageously.

Although specific embodiments have been described for a complete and clear disclosure, the appended claims need not be limited by those embodiments and should be construed as embodying all modifications and alternative constructions that may occur to one skilled in the art that fairly fall within the basic teaching herein set forth.

What is claimed is:

1. A network-based user authentication device that securely authenticates a user's identity by using a pre-registered authenticator in a remote portable terminal of the user, the authentication device, comprising:
a network interface;
a memory that stores user information for the user including authentication information, the authentication information including:
information identifying a pre-registered authenticator within the remote portable terminal; and
a validation code; and
a processor operatively connected to the network interface and the memory, the processor programmed to:
transmit, via the network interface, an identity verification request to the remote portable terminal, the identity verification request requesting verification of the user's identity by the pre-registered authenticator;
receive, via the network interface and in response to the verification request, authentication information from the remote portable terminal, the authentication information identifying the user of the remote portable terminal and including a secret key;
validate the authentication information by comparing the received secret key with the validation code associated with the user in the memory;
when the received secret key and the validation code associated with the user correspond, generate identity verification information confirming the identity of the user; and
transmit, via the network interface, the generated identity verification information to the remote portable terminal.

2. The user authentication device according to claim 1, wherein the validation code was received from the portable remote terminal and stored in the memory as a result of a prior registering of the authenticator.

3. The user authentication device according to claim 1, wherein the identity verification request is transmitted in response to an initial request from the portable remote terminal, the initial request being transmitted in response to a request from a service providing device managed by a provider who provides a service requiring confirmation of the user's identity, the request from the service providing device being transmitted via near field communication.

4. The user authentication device according to claim 1, wherein:
the processor is programmed to receive an initial request from a service providing device managed by a provider who provides the service, the initial request being transmitted when the remote portable device is located within a predetermined range of a location of a facility where the service is provided; and
the identity verification request is transmitted in response to the initial request.

5. The user authentication device according to claim 4, wherein from the service providing device is at least one of an information processing terminal, an access point, and a beacon deployed at the facility.

6. A user authentication method that securely authenticates a user's identity by using a pre-registered authenticator in a remote portable terminal of the user, the method comprising:
accessing a memory that stores user information for the user including authentication information, the authentication information including:
information identifying a pre-registered authenticator within the remote portable terminal; and
a validation code;
transmitting, via a network interface, an identity verification request to the remote portable terminal, the identity verification request requesting verification of the user's identity by the pre-registered authenticator;
receiving, via the network interface and in response to the verification request, authentication information from the remote portable terminal, the authentication information identifying the user of the remote portable terminal and including a secret key;
validating the authentication information by comparing the received secret key with the validation code associated with the user in the memory;
when the received secret key and the validation code associated with the user correspond, generating identity verification information confirming the identity of the user; and
transmitting, via the network interface, the generated identity verification information to the remote portable terminal.

7. A computer-readable storage medium having stored therein a user authentication program that securely authenticates a user's identity by using a pre-registered authenticator in a remote portable terminal of the user, the program causing a computer to execute a process comprising:
accessing a memory that stores user information for the user including authentication information, the authentication information including:
information identifying a pre-registered authenticator within the remote portable terminal; and
a validation code;
transmitting, via a network interface, an identity verification request to the remote portable terminal, the identity verification request requesting verification of the user's identity by the pre-registered authenticator;
receiving, via the network interface and in response to the verification request, authentication information from the remote portable terminal, the authentication information identifying the user of the remote portable terminal and including a secret key;
validating the authentication information by comparing the received secret key with the validation code associated with the user in the memory;
when the received secret key and the validation code associated with the user correspond, generating identity verification information confirming the identity of the user; and
transmitting, via the network interface, the generated identity verification information to the remote portable terminal.
